(19) United States
(12) Patent Application Publication
(10) Pub. No.: US 2024/0124273 A1
(43) Pub. Date: Apr. 18, 2024

(54) LOW-PROFILE, LOW WEIGHT JIB CRANE

(71) Applicant: RAY GIVENS, London (CA)

(72) Inventor: RAY GIVENS, London (CA)

(21) Appl. No.: 18/381,326

(22) Filed: Oct. 18, 2023

Related U.S. Application Data
(60) Provisional application No. 63/417,007, filed on Oct. 18, 2022.

(51) Int. Cl. B66C 23/02

(52) U.S. Cl. CPC B66C 23/027

(57) ABSTRACT

A jib crane, having a low-weight boom with a proximate end, a distal end, a top, a bottom, and a first length between the proximate and distal ends. A high-strength brace extends along the top of the boom from the proximate end by a second length. The boom is mountable to a support structure by way of the brace. The second length may be less than the first length and the brace is attached to the top of the boom and to a pivoting bracket, which is pivotably mounted to the support structure.

### FIELD OF THE INVENTION

The present invention relates to jib cranes and, in particular, to jib cranes for use in low-clearance applications.

### BACKGROUND

Jib cranes are generally constructed with a rail, called the boom or the jib, attached to a free-standing column, pole, post, beam, or another support structure, such as a wall. Generally, the boom is pivotally attached so as to permit it to swing in an arc about the pivot point at one end of the boom. Jib cranes are often used in manufacturing facilities or warehouses to assist an operator in lifting and moving heavy items within a work area defined by the arc of the boom. A hoist is mounted on a track or rail on the boom and slides or is moved along the bridge, between the ends of the boom, to provide for lifting and carrying heavy items within the work area.

Jib crane booms are typically supported only at one end by a pivoting joint. As a result, the load capacity of the jib crane is limited by the length of the boom and the strength of the material it is made of. For this reason, jib cranes are commonly made from steel or other strong, heavy material to provide high load capacity.

A common application for a jib crane is in a manufacturing facility to assist a worker in lifting heavy items from a pallet or conveyor onto a workstation to perform a task and then moving the item onto another pallet or conveyor for transport to another area of the facility. This repetitive movement of the jib crane between locations often involves manually swinging the boom about its pivoting arc, sometimes while sliding the hoist along the boom. Because of the high weight of a long steel boom, it requires significant effort from the worker to swing the boom and also to stop the momentum of the swinging boom. Workers often have a difficult time managing the momentum of a heavy steel I-beam boom during use, which can cause fatigue and contribute to workplace injuries.

One way of overcoming the challenge posed by the high weight of steel I-beam booms is to replace the steel I-beam with an aluminum rail boom. However, the weight capacity of the jib crane is significantly reduced when an aluminum rail is used for the boom, in place of a steel I-beam. In order to address this weight capacity problem with low-weight jib cranes, a diagonal brace or support is pivotally attached to the same pillar or support structure, a distance above the boom. The support is angled diagonally downward and the other end is attached to the boom, typically a short distance from the free end of the boom. This additional support significantly improves the weight capacity of aluminum rail booms in low-weight jib cranes, but it creates a new problem in applications with limited vertical space.

The additional support attached above the boom takes up a significant amount of headroom above the boom of the jib crane. This means that these low-weight jib cranes must have sufficient clearance above the workspace for the workpiece, the hoist, the boom, and the angled support, plus whatever additional clearance is required for maneuvering the workpiece. In many manufacturing environments, (roughly one-third of jib crane applications) there is minimal clearance below overhead conveyors or walkways and this vertical space is simply not available.

Accordingly, there is a need for a low-profile, low-weight jib crane to reduce the strain on workers in applications where the amount of vertical space above the work area is limited.

### SUMMARY OF THE INVENTION

A jib crane, according to the present invention, has a low-weight boom with a proximate end, a distal end, a top, a bottom, and a first length between the proximate and distal ends. A high-strength brace extends along the top of the boom from the proximate end by a second length. The boom is mountable to a support structure by way of the brace.

In another embodiment, the second length is less than the first length.

In another embodiment, the brace is rigidly attached to the top of the boom and is rigidly attached to a pivoting bracket, which is pivotably mountable to the support structure by way of a pair of hinges. The proximate end of the boom rests against the pivoting bracket, but is not directly attached to the pivoting bracket.

In another embodiment, the second length is between 20% and 80% of the first length. In another embodiment, the second length is about 50% of the first length.

In another embodiment, the brace extends adjacent and parallel to the top of the boom and has an upside-down U-shaped cross section that with flanges that extend down the sides of the boom.

In another embodiment, the boom comprises an upper boom and a lower boom having a length greater than the length of the upper boom.

### BRIEF DESCRIPTION OF THE DRAWINGS

In order that the invention may be more clearly understood, a preferred embodiment thereof will now be described in detail by way of example, with reference to the accompanying drawings, in which:

FIG. 1 is a perspective view of a jib crane, according to the present invention, shown pivotally mounted on a column.

FIG. 2 is a perspective detail view of the proximate end of the crane of FIG. 1.

FIG. 3 is a perspective view of another embodiment of the jib crane, according to the present invention, shown pivotally mounted on a column.

FIG. 4 is a perspective detail view of the proximate end of the crane of FIG. 3.

FIG. 5 is a perspective view of the jib crane of FIG. 1, with an alternate brace.

### DESCRIPTION OF THE INVENTION

The jib crane, according to the present invention, has a light-weight boom reinforced by a high-strength brace extending adjacent and parallel to the top of the boom. The high-strength brace extends along at least a portion of the length of the boom to increase the weight capacity of the light-weight boom, while keeping the overall weight of the boom as low as possible to facilitate easy manipulation by a user of the jib crane. This configuration of the brace and the boom also minimizes the amount of vertical space required for the jib crane and permits it to operate with both a light weight and a low profile.

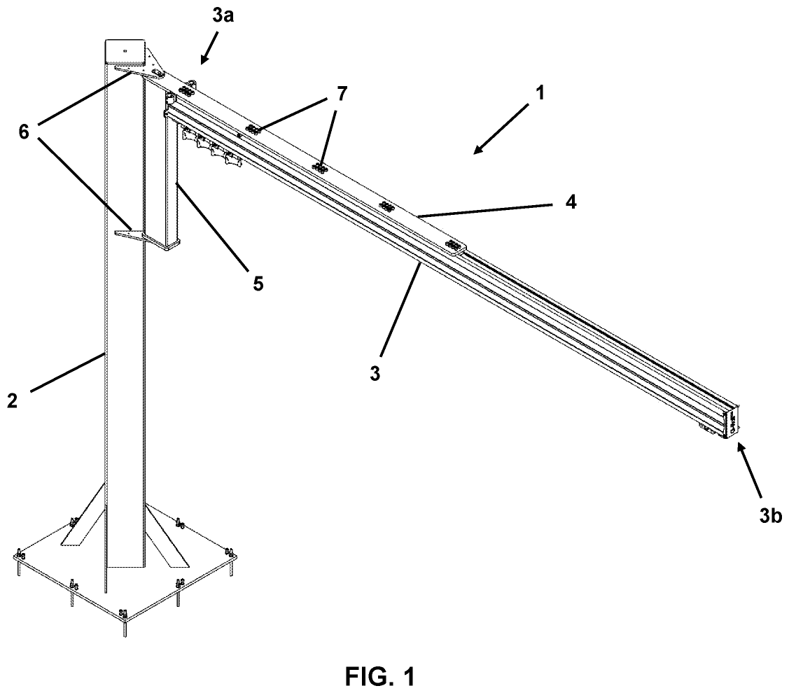

As shown in FIG. 1, the crane 1 is attached to a support structure, such as a column 2, and extends outwardly from the column 2 over a work area. Other support structures, such as existing structural beams or walls of a building, may also provide sufficient rigid support for the crane 1, but the example of a steel column 2 will be used to describe the invention herein. Preferably, the crane 1 is pivotably attached to the column 2 to permit it to swing in an arc about the column 2, but it may be rigidly attached in certain applications where a wider range of motion is not required. The column 2 may be rigidly attached to the floor of a building or otherwise fixed in place on or to a structure, object, or vehicle of sufficient stability and weight to facilitate the lifting and moving of loads by the crane 1.

The crane 1 has a light-weight boom 3 attached to a high-strength brace 4 that extends adjacent to and parallel to the boom 3. The boom 3 is made of a light-weight material, such as aluminum, carbon-fiber, or other light-weight material with suitable rigidity, to minimize the weight of the crane 1. The boom 3 may be any configuration of rail suitable for jib cranes, such as enclosed track or I-beam style boom. The boom 3 has a proximate end 3a adjacent to the column 2 and an opposing distal end 3b.

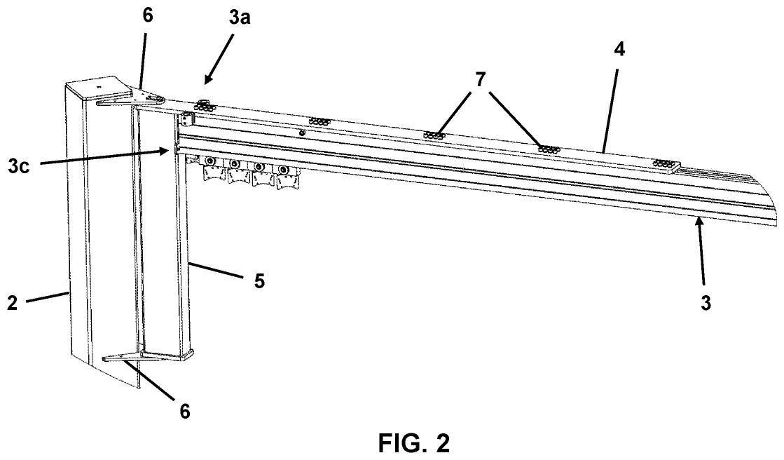

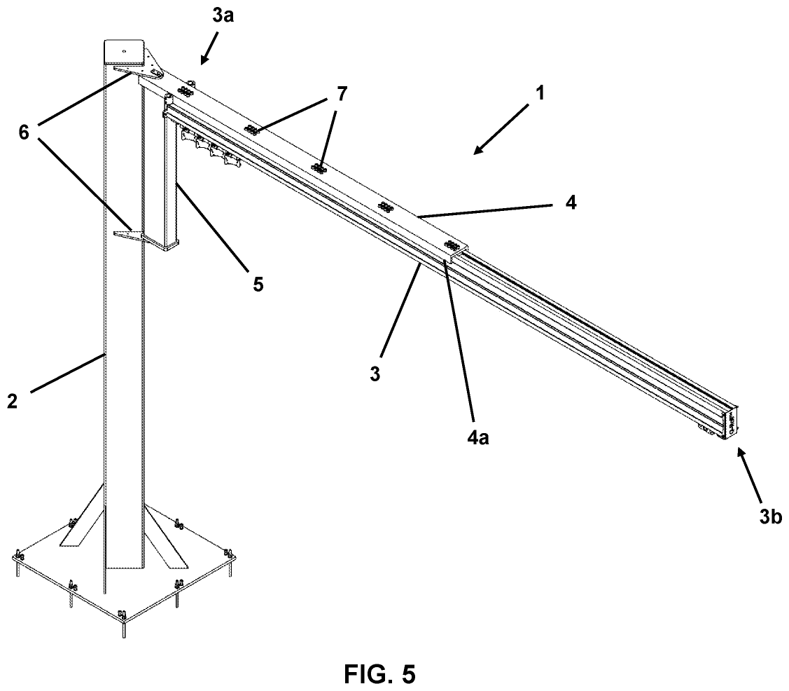

As shown in FIG. 2, the boom 3 is attached, adjacent its proximate end 3a, to the brace 4. The brace 4 is made of a high-strength material, such as steel or other high-strength material to provide sufficient additional support to the boom 3 to meet the operational requirements of the crane 1, such as carrying capacity. The brace 4 is attached to the top of the boom 3 adjacent the proximate end 3a of the boom 3 and extends along the top of the boom 3 towards the distal end 3b. Preferably, the brace 4 extends less than the full length of the boom 3, more preferably between 20% and 80% of the length of the boom 3, or about 50% of the length of the boom 3. As shown in FIGS. 1-4, the brace 4 is a flat bar that extends only along the top of the boom 3. Alternatively, the brace 4 may have other shapes or configurations, such as a channel or tube-shaped brace 4. In one preferred alternative, the brace 4 in an upside-down U-shaped channel brace 4, which extends along the top of the boom 3 and has flanges 4a that extend a short distance down the sides of the boom 3, as shown in FIG. 5. Any configuration or geometry of brace 4 may be used, provided that it supports the boom 3 without requiring substantial additional headroom, thereby maintaining the low-profile of the crane 1.

The brace 4 is generally made of a heavier material, with a greater mechanical strength, relative to the light-weight material of the boom 3. Because less material is required to form the brace 4 than to form the entire boom 3, the overall weight of the crane 1 may be kept to a minimum. Additionally, the heavier parts of the crane are located at the proximate end 3a of the boom 3, closest to the column 2. It is particularly important to minimize the weight of longer cranes 1 and of the portions of the crane farthest from the column 2, due to the relationship between the torque and the positioning of the weight of the crane 1 relative to the column 2 (i.e. relative to the centre of rotation).

As mentioned above, the boom 3 is, preferably, pivotably mounted to the column 2. This may be accomplished by connecting the boom 3 to a pivoting bracket 5, by way of the brace 4. As shown in FIG. 2, the bracket 5 is a bar or beam attached vertically, adjacent to the column 2 between a pair of hinges 6 rigidly attached to the column 2. Alternatively, other suitable rotatable attachments may be used to permit the bracket 5 to swing freely about a pivot point on or adjacent to the column 2. The brace 4 is rigidly attached to the bracket 5, preferably by welding since both the brace 4 and the bracket 5 will generally be made of steel. Because the boom 3 is preferably made from aluminum, it is difficult to weld to either the brace 4 or the bracket 5, which are preferably made from steel and available welding techniques are generally not practical or will not provide adequate weld strength. Accordingly, the boom 3 is attached to the brace 4 by way of fasteners 7 along the top of the boom 3 and the length of the brace 4. Preferably, the boom 3 is not directly attached to the bracket 5 and is only connected via the brace 4. Optionally, the boom 3 may also be directly attached to the bracket 5, but it may also simply rest against the bracket 5 and be connected only by way of the brace 4.

Without wishing to be bound by theory, it is believed that the crane 1 is able to provide significantly improved carrying capacity, while maintaining an extremely low weight compared to other light-weight, low-profile jib cranes, because of this unusual attachment of the boom 3 to the column 2, by way of the brace 4, as described above. In certain preferred embodiments, the crane 1 has three to four times the carrying capacity of the same aluminum boom 3, without the steel brace 4. This configuration results in extremely high tension loads on the brace 4 and extremely high compression loads on the bottom corner of the proximate end 3a of the boom 3, when the crane 1 is in use. Because the boom 3 is made of a weaker material, such as aluminum, the bearing surface 3c at the bottom corner of the proximate end 3a may be widened or otherwise reinforced to spread or otherwise accommodate the high compression loads during operation.

The other components of the crane 1, such as the hoist, festooning, etc. (not shown) are mounted on the boom 3 and travel along a track or rail on the boom 3 during operation. The hoist may be any suitable type of hoist, such as an electric, pneumatic, or manual chain or wire rope hoist. Preferably, no braces or supports are attached along the bottom of the boom 3, to permit the track for the hoist and other components to run as close to the column 2 as possible. However, there are certain applications in which it is not necessary for the hoist, trolleys, and other components to be permitted to travel as close as possible to the proximate end 3a of the boom 3, during use. In these cases, braces or supports may be placed on the sides or bottom of the boom 3 in addition to, or in place of, the brace 4 along the top of the boom 3.

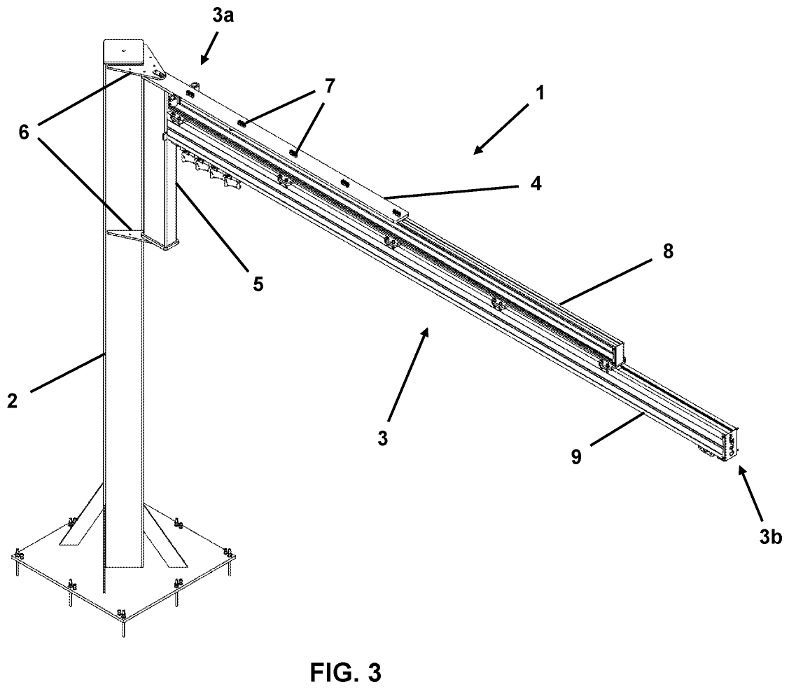

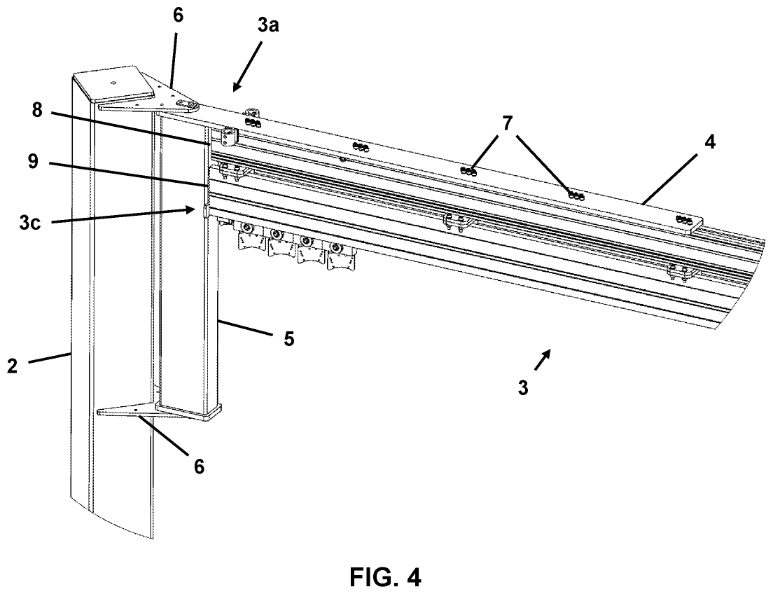

As shown in FIGS. 3 and 4, an alternative configuration of the of the boom 3 may be used in certain applications where higher weight capacity is required. The boom 3 may have an upper boom 8 and lower boom 9, which are rigidly attached to one another. The upper boom 8 is attached to the column 2 by way of the brace 4, as described above for the preferred boom 3, but does not extend the full length of the crane 1. Rather, the upper boom 8 is longer than the brace 4, but shorter than the lower boom 9. In this configuration, the track or rail on which the hoist, festooning, and other components of the crane 1 travel is located on the lower boom 9 and the lower boom 9 is rigidly attached to the upper boom 8, by way of fasteners 7, welding or other suitable means of rigid attachment. By using an upper boom 8, which is shorter than the lower boom 9, the weight of the crane 1 at the distal end 3b can be further reduced in applications that require higher carrying capacity, compared to using a single, larger boom 3, without significantly compromising the carrying capacity of the crane 1.

The present invention has been described and illustrated with reference to an exemplary embodiment, however, it will be understood by those skilled in the art that various changes may be made and equivalents may be substituted for elements thereof without departing from the scope of the invention as set out in the following claims. Therefore, it is intended that the invention not be limited to the particular embodiments disclosed herein.

What is claimed is:

1. A jib crane, comprising:
a light-weight boom having a proximate end, a distal end, a top, a bottom, and a first length between the proximate end and the distal end;
a high-strength brace extending along the top of the boom from the proximate end by a second length; and
wherein the boom is mountable to a support structure by way of the brace.

2. The jib crane of claim 1, wherein the second length is shorter than the first length.

3. The jib crane of claim 2, wherein brace is rigidly attached to the top of the boom and is rigidly attached to a pivoting bracket, which is pivotably mountable to the support structure by way of a pair of hinges.

4. The jib crane of claim 3, wherein the proximate end of the boom rests against the pivoting bracket, but is not directly attached to the pivoting bracket.

5. The jib crane of claim 3, wherein the pivoting bracket comprises a bar mounted between the hinges.

6. The jib crane of claim 3, wherein the brace is a flat bar extending adjacent and parallel to the top of the boom.

7. The jib crane of claim 3, wherein the brace extends adjacent and parallel to the top of the boom and has an upside-down U-shaped cross section with flanges that extend from the top of the boom a distance toward the bottom of the boom.

8. The jib crane of claim 3, wherein the brace is attached to the pivoting bracket by welding and is attached to the boom by way of one or more fasteners.

9. The jib crane of claim 8, wherein the boom is made of aluminum and the brace is made of steel.

10. The jib crane of claim 8, wherein a bearing surface at the proximate end of the boom adjacent the bottom of the boom is reinforced.

11. The jib crane of claim 3, wherein the boom comprises an upper boom and a lower boom, wherein the brace is attached to the upper boom and the upper boom has a length longer than the second length, but shorter than the first length, and wherein the lower boom has a length equal to the first length and is attached to the upper boom.

12. The jib crane of claim 3, wherein the support structure is a column.
